(19) United States
(12) Patent Application Publication
(10) Pub. No.: US 2004/0223537 A1
(43) Pub. Date: Nov. 11, 2004

(54) Method and device for receiving a radio signal

(75) Inventors: Moussa Abdi, Paris (FR); Alexandre Jard, Suresnes (FR); Hassan El Nahas El Homsi, Paris (FR); Jean-Marc Corbel, Paris (FR)

Correspondence Address: Michael L. Kenaga, PIPER RUDNICK LLP, P.O. Box 64807, Chicago, IL, 60664-0807, US

(73) Assignee: NORTEL NETWORKS LIMITED.

(21) Appl. No.: 10/766,968

(22) Filed: Jan. 28, 2004

(30) Foreign Application Priority Data
Jan. 29, 2003 (FR) 03/00983

(51) Int. Cl. H04B 1/707

(52) U.S. Cl. 375/147

(57) ABSTRACT

The signal received comprises contributions from several channels multiplexed by respective spreading codes. After having estimated response parameters of the channels, soft estimates of the symbols transmitted are calculated. These symbols are then apportioned between a first set of symbols satisfying a confidence criterion applied to the calculated soft estimates and a second set of symbols not satisfying this criterion. A modified signal is determined by subtracting estimated contributions corresponding to the symbols of the first set from the signal received. New soft estimates of the symbols of the second set only are calculated, as a function of the modified signal and of the estimated response parameters, and this may be done with a detection algorithm of more complex nature, in particular a multi-user algorithm, by virtue of the size reduction performed by restricting oneself to the symbols of the second set.

### BACKGROUND OF THE INVENTION

The present invention relates to digital radiocommunication techniques using Code Division Multiple Access (CDMA).

A CDMA signal processed by a receiver can be expressed, after filtering and transposition to baseband, as follows:

$$y ( t ) = {\sum }_{u = 1}^{U} {y}^{U} ( t ) + n ( t ) \qquad ( 1 )$$

where n(t) is additive noise and U is the number of channels multiplexed on the CDMA carrier, whose contributions y^{u}(t) have as a general expression:

$${y}^{u} ( t ) = {\sum }_{i} {b}_{i}^{u} \cdot {s}_{i}^{u} ( t - iT ) \qquad ( 2 )$$

where:

bᵢ^{u} is the information symbol of rank i transmitted on the u-th channel;

sᵢ^{u}(t) is a generalized code given by the convolution of the impulse response of the u-th channel with the portion corresponding to the symbol of the spreading code c^{u} assigned to the channel.

The number U corresponds to the number of user if each user involved utilizes a single channel. There may however be several channels per user.

The spreading codes c^{u} are sequences of discrete samples called “chips”, with real values (±1) or complex values (±1±j), having a given chip rate. The symbols bᵢ^{u} also have real values (±1) or complex values (±1±j). The duration of a symbol on a channel is a multiple of the chip duration, the ratio of the two being the channel spreading factor Q.

In certain systems, the spreading factor may vary from one channel to another. In such a case, a common spreading factor Q is considered, equal to the greatest common divisor (GCD) of the U spreading factors Q^{u}. A symbol on the channel u is then regarded as the concatenation of Q^{u}/Q consecutive symbols bᵢ^{u} whose values are identical.

The duration of the generalized response Sᵢ^{u}(t) corresponds to Q+W−1 chips if W denotes the length of the impulse response expressed as a number of chips.

By sampling at the chip rate the CDMA signal y(t) received for a block of n symbols on each of the channels, the receiver obtains complex samples that can be modeled by a vector Y of n×Q+W−1 components:

Y=A.b+N (3)

where:

b denotes a column vector of size n×U, which can be decomposed into b^{T}=(b₁^{T},b₂^{T}, . . . ,bₙ^{T}), where (.)^{T} represents the transposition operation, the vectors bᵢ being of size U for 1≦i≦n, with bᵢ^{T}=(bᵢ¹, bᵢ², . . . ,bᵢ^{U});

N is a random noise vector of size n×Q+W−1;

A=(A₁, A₂, . . . , Aₙ) is a matrix of generalized codes of size (n×Q+W−1)×(n×U) which can be subdivided into n sub-matrices Aᵢ of size (n×Q+W−1)×U. In the matrix Aᵢ (1≦i≦n), the u-th column (1≦u≦U) is a convolution of the impulse response of the u-th channel and of the Q samples of the spreading code of the u-th channel corresponding to the i-th symbol of the block.

In other words, the matrices Aᵢ may be written:

Aᵢ=(Ωᵢ¹, Ωᵢ², . . . ,Ωᵢ^{u}) (4)

with:

Ωᵢ^{u}=Mᵢ^{u}.Hᵢ^{u} (5)

where Mᵢ^{u} is a Toeplitz matrix of size (n×Q+W−1)×(n×Q+W−Q) obtained from the values cᵢ^{u}(q) of the chips of the spreading code c^{u} of the u-th channel over the duration of the i-th bit of the block:

$${M}_{i}^{u} = ( \begin{matrix}{c}_{i}^{u} ( 1 ) & 0 & ⋯ & 0 \\ {c}_{i}^{u} ( 2 ) & {c}_{i}^{u} ( 2 ) & ⋰ & ⋮ \\ & {c}_{i}^{u} ( 2 ) & ⋰ & 0 \\ {c}_{i}^{u} ( Q ) & & ⋰ & {c}_{i}^{u} ( 1 ) \\ 0 & {c}_{i}^{u} ( Q ) & & {c}_{i}^{u} ( 2 ) \\ ⋮ & ⋰ & ⋰ & ⋮ \\ 0 & ⋯ & 0 & {c}_{i}^{u} ( Q )\end{matrix} ) \qquad ( 6 )$$

and Hᵢ^{u} is a column vector of size (n−1)×Q+W which, when the U channels are received synchronously, contains (i−1)×Q zero components, followed by the W samples of the u-th channel's impulse response relating to the i-th symbol bᵢ^{u}, and followed by (n−i)×Q other zero components. The time offsets in reception along the various channels, in numbers of chips, are manifested as corresponding offsets of the W samples of the impulse response of the channels along the vector Hⁱᵤ.

The receiver most commonly used, the so-called rake receiver, uses one or more matched filters to estimate the value of the symbols transmitted on each channel from an estimate of the impulse response of the channel along one or more propagation paths.

The operation performed by such receivers amounts to performing the matrix product:

Z=Â*.Y (7)

where Â* is the conjugate transpose of an estimate Â=(Â₁, Â₂, . . . , Âₙ) of the matrix A, the matrices Âᵢ stemming from the impulse responses estimated by applying relations (4) and (5).

The n×U components Zᵢ^{u} of the vector Z are respective soft estimates of the n×U symbols bᵢ^{u} of the vector b. If the decodings performed downstream admit soft estimates as input, the components of the vector Z can be used directly. Otherwise, the sign of these components is taken to form the hard estimates of the symbols.

The matched filter receiver is optimal when the generalized codes (vectors Ωᵢ^{u}) are pairwise orthogonal, i.e. when the correlation matrix R=A*.A is diagonal. In general, the systems adopt pairwise orthogonal spreading codes having good autocorrelation properties, whereby this condition is fulfilled to a first approximation.

However, when the impulse response of the channel is taken into account, the orthogonality condition is no longer fulfilled. The above approximation becomes poor especially in the presence of multiple propagation paths.

Certain receivers carry out a posteriori correction of the soft estimates of the symbols emanating from the matched filter receiver by taking account of the inter-users interference and/or of the inter-symbol interference on one and the same channel, thereby substantially improving the performance. Such a procedure, based on a so-called MFPIC (“Matched Filter Parallel Interference Cancellation”) algorithm, is disclosed in WO 01/99301. Its advantage is that it does not overly increase the global complexity of the calculations with respect to the traditional “rake” receiver. However, these a posteriori corrections follow upon an optimization of the system (3) relying on the above approximation.

This MFPIC algorithm belongs to the class of multiuser detection algorithms (MUD) that offer better performance than the regular matched filter receiver. This class includes more accurate algorithms than MFPIC, in that they can take into account the terms of the matrix R that are farther from its diagonal.

A good example of a MUD algorithm useable in such a context is the SDP algorithm described in the article by M. Abdi, et al., “Semidefinite Positive Relaxation of the Maximum-Likelihood Criterion Applied to Multiuser Detection in a CDMA Context”, IEEE Signal Processing Letters, Vol. 9, No. 6, June 2002, pp. 165 167.

The better performance of these MUD algorithms is obtained at the price of greatly increased complexity. In general, their complexity is more than linear in the size n×U of the problem to be solved, this rendering them very expensive by comparison with more conventional receivers such as the “rake” or the MFPIC.

An object of the present invention is to find a good compromise between the performance and the complexity of a CDMA receiver.

### SUMMARY OF THE INVENTION

The invention thus proposes a method of processing a signal received via a radio interface and including contributions from a plurality of channels multiplexed by respective spreading codes. The method comprises the steps of:

/a/ estimating response parameters of the multiplexed channels;

/b/ calculating soft estimates of symbols transmitted over the multiplexed channels, as a function of the received signal and of the estimated response parameters;

/c/ dividing the symbols whose soft estimates have just been calculated between a first set of symbols satisfying a confidence criterion applied to said soft estimates and a second set of symbols not satisfying the confidence criterion;

/d/ determining a modified signal by subtracting estimated contributions corresponding to the symbols of the first set, respectively, from the signal subjected to the previous calculation of soft estimates; and

/e/ calculating new soft estimates of the symbols of the second set only, as a function of the modified signal and of the estimated response parameters.

The symbols for which the first calculation affords sufficiently reliable estimates are no longer to be estimated in the second calculation. Their contribution to the signal is deducted so as to take into account the interference that they generate for the other symbols.

Various detection algorithms can be employed for the successive calculations of soft estimates.

In a preferred embodiment of the method, step /e/ is executed according to a detection algorithm of more complex nature than step /b/, in particular according to a multi-user detection algorithm. The method then profits from the performance of a complex algorithm of MUD type, but by applying the latter to a problem of smaller size than the problem forming the subject of the first calculation.

The method thus makes it possible to achieve a compromise between the symbols detection performance and the complexity of the required calculations. In the design or the configuration of the receiver, it is possible to favor the performance or the complexity in this compromise, by appropriate adjustment of the confidence criterion employed.

It is moreover possible to repeat the sequence of steps /c/ to /e/ one or more times. The larger or smaller number of iterations and/or the severity of the confidence criterion applied at each iteration (this confidence criterion may vary from one iteration to the next) are parameters that may also be adjusted as a function of the performance/complexity compromise sought.

Another aspect of the present invention pertains to a device for processing a signal received via a radio interface, including contributions from a plurality of channels multiplexed by respective spreading codes. This device comprises means for estimating response parameters of the multiplexed channels, first means for calculating soft estimates of symbols transmitted over the multiplexed channels, as a function of the received signal and of the estimated response parameters, means for dividing the symbols between a first set of symbols satisfying a confidence criterion applied to the soft estimates produced by the first means for calculating and a second set of symbols not satisfying the confidence criterion, means for determining a modified signal by subtracting estimated contributions corresponding to the symbols of the first set, respectively, from the received signal, and second means for calculating new soft estimates of the symbols of the second set only, as a function of the modified signal and of the estimated response parameters.

Such a device can in particular be incorporated into a base station of a CDMA radiocommunication system.

When several iterations are envisaged, the device further comprises second means for dividing the symbols of the second set between a first subset of symbols satisfying a second confidence criterion applied to the soft estimates produced by the second means for calculating and a second subset of symbols not satisfying the second confidence criterion, means for determining a second modified signal by subtracting estimated contributions corresponding to the symbols of the first subset, respectively, from the modified signal which was subjected to the second means for calculating, and third means for calculating new soft estimates of the symbols of the second subset only, as a function of the second modified signal and of the estimated response parameters.

Another aspect of the present invention pertains to a computer program to be installed in a radiocommunication receiver, the program comprising instructions for implementing a method as defined hereinabove during execution of the program by a signal processing unit of the receiver.

### BRIEF DESCRIPTION THE DRAWINGS

FIG. 1 is a schematic diagram of an exemplary reception device according to the invention.

FIG. 2 is a flow chart of an exemplary method according to the invention.

### DESCRIPTION OF PREFERRED EMBODIMENTS

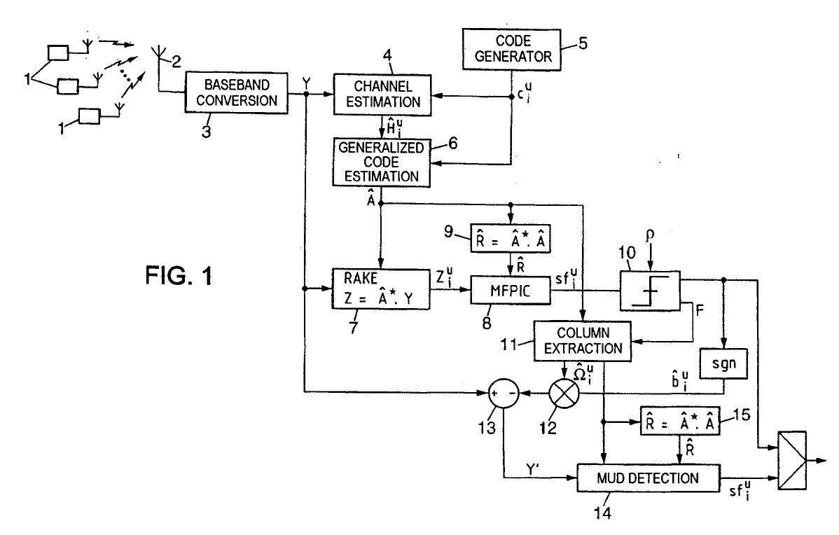

The device represented in FIG. 1 is part of the receiving stage of a radiocommunication station able to communicate with several remote stations 1.

The uplink channels used by these distant stations 1 are multiplexed by the CDMA technique, so that the radio signal picked up by the antenna 2, and converted to baseband, can be represented in the form (1)-(2) for U multiplexed channels originating from V stations (1≦V≦U).

The station incorporating the device is for example a base station of a third-generation cellular radiocommunication system of the UMTS (“Universal Mobile Telecommunication System”) type.

In FIG. 1, the unit 3 diagrammatically represents the modules performing in a conventional manner the signal reception preprocessing (amplification, filtering, conversion to baseband, sampling at the chip frequency). This unit 3 delivers blocks Y of n×Q+W−1 samples, corresponding to blocks of n symbols transmitted simultaneously on the U channels. If the blocks of n symbols follow one another without interruption on the channels, there is an overlap of W samples (chips) between the successive blocks Y, corresponding to the duration of the impulse response.

The received-signal blocks Y are provided to a module 4 which estimates the impulse responses Ĥᵢ^{u} of the U multiplexed CDMA channels, with the aid of correlations with the spreading codes produced by pseudorandom code generators 5 (1≦u≦U, 1≦i≦n). The module 6 then estimates the matrix Â of the generalized codes according to (4) and (5), i.e. its [(i−1)×U+u]-th column is given by \hat{Ω}ᵢ^{u}=Mᵢ^{u}.Ĥᵢ^{u}.

With the aid of the parameters of the matrix Â, a first calculation of soft estimates is applied to the block Y. In the example represented, this first calculation is effected by the modules 7 to 9 according to the MFPIC algorithm described in WO 01/99301. The module 7 performs a conventional detection of “rake” type on each channel, according to relation (7) above. It produces first soft estimates Zᵢ^{u} of the transmitted symbols bᵢ^{u}. These first estimates Zᵢ^{u} could be used directly, but their representativity is improved by refining them in the module 8, which applies the correction envisaged in the MFPIC algorithm to take account of inter-symbol interference and/or inter-user interference. In the case where the symbols transmitted are bits, this correction is expressed by:

$${sf}_{i}^{u} = {Z}_{i}^{u} - {\sum }_{{j = 1}_{j \neq i}}^{n} {\hat{R}}_{i , j}^{u , u} \cdot sgn ( {Z}_{j}^{u} ) - {\sum }_{{v = 1}_{v \neq u}}^{U} {\sum }_{j = 1}^{n} {\hat{R}}_{i , j}^{u , v} \cdot sgn ( {Z}_{j}^{v} ) \qquad ( 8 )$$

where sgn(.) designates the sign function with values in {−1, +1} and \hat{R}_{i,j}^{u,v} designates the term situated in the [(i−1)×U+u]-th row and the [(j−1)×U+v]-th column of the correlation matrix \hat{R}=Â*.Â calculated by the module 9.

The first term subtracted in (8) corresponds to inter-symbol interference on the u-th channel while the second term subtracted corresponds to the inter-channel interference. The estimates sfᵢ^{u} produced by the module 8 are approximations of the “softbits”, to within a multiplicative coefficient 4/σ², where a designates the power of the additive noise picked up, an estimate of which is conventionally made available by the probing module 4. The sign of sfᵢ^{u} forms a hard estimate of the bit bᵢ^{u}, while its absolute value measures the likelihood of this estimate.

According to the invention, these soft estimates sfᵢ^{u} are examined by a module 10 in such a way as to identify a set F of symbols whose estimates are regarded as the most reliable.

By way of example, the module 10 sorts the estimates sfᵢ^{u} in the order of descending absolute values and places in the set F the K% of the symbols whose estimates are ranked first. Another possibility is to place in the set F the symbols whose estimates sfᵢ^{u} have an absolute value greater than a confidence threshold ρ that can be taken proportional to 4/σ². The threshold ρ or the percentage K can be made adaptive, for example as a function of the signal-to-noise ratio observed by the receiver.

For the symbols of the set F which is thus determined, the device will deliver the soft estimates sfᵢ^{u} produced by the module 8 or hard estimates \hat{b}ᵢ^{u} consisting of their signs, according to the requirements of the processing circuits situated downstream.

The symbols that do not form part of this set will form the subject of a second calculation of soft estimates which preferably uses an MUD algorithm.

The columns of the matrix of the generalized codes Â are sorted by a module 11. Each column \hat{Ω}ᵢ^{u} associated with a symbol of the set F is extracted from Â so as to be multiplied by the hard estimate \hat{b}ᵢ^{u} of this symbol (multiplier 12), thereby giving an estimate of the contribution of the interference caused by this symbol on the others. This contribution \hat{b}ᵢ^{u}.\hat{Ω}ᵢ^{u} is subtracted from the vector Y representing the input signal by the subtractor 13. Such a subtraction is performed for each symbol of the set F:

$$\begin{matrix}{Y}^{′} = Y - {\sum }_{( i , u ) ∈ F} {\hat{b}}_{i}^{u} \cdot {\hat{Ω}}_{i}^{u} & ( 9 ) \\ = {\sum }_{i = 1}^{n} {\sum }_{u = 1}^{U} {b}_{i}^{u} \cdot {Ω}_{i}^{u} + N - {\sum }_{( i , u ) ∈ F} {\hat{b}}_{i}^{u} \cdot {\hat{Ω}}_{i}^{u} & ( 10 ) \\ \approx {\sum }_{( i , u ) ∉ F} {\hat{b}}_{i}^{u} \cdot {\hat{Ω}}_{i}^{u} + N & ( 11 )\end{matrix}$$

The relation (11) shows that by taking into account the contributions of the properly estimated symbols, the size of the system to be processed is reduced from n×U to n×U−card(F). The size reduction is very appreciable if it has been possible to properly estimate sufficient symbols during the first pass. This facilitates recourse to an algorithm of more complex nature for the second estimate of the remaining symbols, in particular to an MUD algorithm.

This second estimate is performed by the detection module 14 of FIG. 1, to which the modified signal Y′ is subjected. Each column vector \hat{Ω}ᵢ^{u} with (i,u)∈F is removed from the matrix Â by the module 11 so as to form a reduced matrix of generalized codes according to which the module 15 obtains the reduced correlation matrix \hat{R}=Â*.Â. The vector Y′ and the reduced matrices Â and \hat{R} constitute the input data for the MUD algorithm implemented by the module 14, which is for example the aforesaid SDP algorithm.

The soft estimates sfᵢ^{u} (or hard estimates) produced by the MUD module 14 are ultimately combined with the estimates determined in a sufficiently reliable manner by the MFPIC algorithm in the course of the first pass, so as to reconstruct the set of demodulated data.

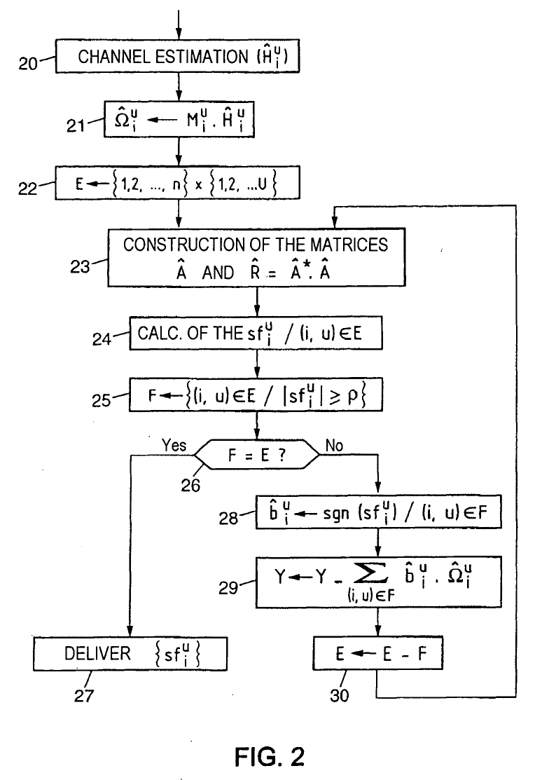

The soft estimates sfᵢ^{u} produced by this MUD module 14 may also form the subject of a sorting between reliable estimates and unreliable estimates, the latter then forming the subject of a new calculation of estimates. This sorting and re-estimation process can be repeated a certain number of times. Such iterative procedure is illustrated by FIG. 2.

The first two steps 20 and 21, prior to the iterations, consist of the conventional estimation of the responses of the channels and of the generalized codes \hat{Ω}ᵢ^{u} (operations of the modules 4 and 6 of FIG. 1). In step 22, the set E of the symbols to be estimated in the course of the next iteration is initialized to the Cartesian product {1,2, . . . ,n}×{1,2, . . . ,U} corresponding to the entirety of the symbols transmitted within the current block over the channels to be processed.

In each iteration, the first step 23 consists in assembling the column vectors \hat{Ω}ᵢ^{u} associated with the symbols of the set E to form the matrix of codes Â which will be used for the next detection, and in calculating the correlation matrix \hat{R}=Â*.Â. The detection is effected in the next step 24 on the basis of the block Y with the aid of the matrices Â and \hat{R}. By way of example, the algorithm employed in step 24 is the MFPIC in the first iteration and the SDP in each subsequent iteration.

The soft estimates obtained in step 24 are subjected to the confidence criterion so as to construct, in step 25, the set F of indices (i,u) of the most reliable symbols, which are for example the indices (i,u) of the set E such that |sfᵢ^{u}|≧ρ.

If all the estimates are deemed sufficiently reliable (F=E in test 26), the detection procedure is terminated and the soft estimates sfᵢ^{u} which were calculated may be delivered in step 27. The threshold p can vary in the course of the iterations. It may in particular decrease so as to make the confidence criterion less and less severe. To limit the procedure to a maximum number X of iterations, it is possible to set ρ=0 for the X-th iteration.

If certain estimates are not sufficiently reliable (F≠E in test 26), the hard estimates \hat{b}ᵢ^{u} of the symbols of F are determined in step 28. The estimated contributions \hat{b}ᵢ^{u}.\hat{Ω}ᵢ^{u} of these symbols are subtracted from block Y in step 29 (operation of the modules 12 and 13 of FIG. 1). To initialize the next iteration, the set E of symbols to be estimated is updated in step 30 by deleting therefrom the correctly estimated symbols of the set F.

A procedure such as that illustrated by FIG. 2 can be implemented by programming a digital signal processor provided in the radio receiver.

1. A method of processing a signal received via a radio interface, including contributions from a plurality of channels multiplexed by respective spreading codes, the method comprising the steps of:
/a/ estimating response parameters of the multiplexed channels;
/b/ calculating soft estimates of symbols transmitted over the multiplexed channels, as a function of the received signal and of the estimated response parameters;
/c/ dividing the symbols whose soft estimates have just been calculated between a first set of symbols satisfying a confidence criterion applied to said soft estimates and a second set of symbols not satisfying the confidence criterion;
/d/ determining a modified signal by subtracting estimated contributions corresponding to the symbols of the first set, respectively, from the signal subjected to the previous calculation of soft estimates; and
/e/ calculating new soft estimates of the symbols of the second set only, as a function of the modified signal and of the estimated response parameters:

2. The method as claimed in claim 1, wherein step /e/ is executed according to a detection algorithm of more complex nature than step /b/.

3. The method as claimed in claim 1, wherein step /e/ is executed according to a multi-user detection algorithm.

4. The method as claimed in claim 1, further comprising the step of repeating at least once the sequence of steps /c/ to /e/.

5. The method as claimed in claim 4, wherein the confidence criterion varies from one iteration of the sequence of steps /c/ to /e/ to the next.

6. The method as claimed in claim 1, wherein the confidence criterion is expressed as a proportion of the lowest soft estimates.

7. The method as claimed in claim 1, wherein the confidence criterion is expressed as a confidence threshold to be reached by the soft estimates of the symbols.

8. A device for processing a signal received via a radio interface, including contributions from a plurality of channels multiplexed by respective spreading codes, the device comprising means for estimating response parameters of the multiplexed channels, first means for calculating soft estimates of symbols transmitted over the multiplexed channels, as a function of the received signal and of the estimated response parameters, means for dividing the symbols between a first set of symbols satisfying a confidence criterion applied to the soft estimates produced by the first means for calculating and a second set of symbols not satisfying the confidence criterion, means for determining a modified signal by subtracting estimated contributions corresponding to the symbols of the first set, respectively, from the received signal, and second means for calculating new soft estimates of the symbols of the second set only, as a function of the modified signal and of the estimated response parameters.

9. The device as claimed in claim 8, wherein the second means for calculating are arranged to apply a detection algorithm of more complex nature than the first means for calculating.

10. The device as claimed in claim 8, wherein the second means for calculating are arranged to apply a multi-user detection algorithm.

11. The device as claimed in claim 8, further comprising second means for dividing the symbols of the second set between a first subset of symbols satisfying a second confidence criterion applied to the soft estimates produced by the second means for calculating and a second subset of symbols not satisfying the second confidence criterion, means for determining a second modified signal by subtracting estimated contributions corresponding to the symbols of the first subset, respectively, from the modified signal which was subjected to the second means for calculating, and third means for calculating of new soft estimates of the symbols of the second subset only, as a function of the second modified signal and of the estimated response parameters.

12. A computer program product for running in a radiocommunication receiver, the program comprising instructions for carrying out the following steps upon execution of the program by a signal processing unit of the receiver:
/a/ estimating response parameters of the multiplexed channels;
/b/ calculating soft estimates of symbols transmitted over the multiplexed. channels, as a function of the received signal and of the estimated response parameters;
/c/ dividing the symbols whose soft estimates have just been calculated between a first set of symbols satisfying a confidence criterion applied to said soft estimates and a second set of symbols not satisfying the confidence criterion;
/d/ determining a modified signal by subtracting estimated contributions corresponding to the symbols of the first set, respectively, from the signal subjected to the previous calculation of soft estimates; and
/e/ calculating new soft estimates of the symbols of the second set only, as a function of the modified signal and of the estimated response parameters.

13. The computer program product as claimed in claim 12, further comprising instructions for executing step /e/ according to a detection algorithm of more complex nature than step /b/.

14. The computer program product as claimed in claim 12, further comprising instructions for executing step /e/ according to a multi-user detection algorithm.

15. The computer program product as claimed in claim 12, further comprising instructions for repeating at least once the sequence of steps /c/ to /e/.

16. The computer program product as claimed in claim 15, wherein the confidence criterion varies from one iteration of the sequence of steps /c/ to /e/ to the next.

17. The computer program product as claimed in claim 12, wherein the confidence criterion is expressed as a proportion of the lowest soft estimates.

18. The computer program product as claimed in claim 12, wherein the confidence criterion is expressed as a confidence threshold to be reached by the soft estimates of the symbols.
